(19) United States
(12) Patent Application Publication
(10) Pub. No.: US 2019/0045027 A1
(43) Pub. Date: Feb. 7, 2019

(54) PUBLIC FACILITY SYSTEM, USER TERMINAL, SERVER, AND INTERNET OF THINGS SYSTEM

(71) Applicant: BOE Technology Group Co., Ltd., Beijing (CN)

(72) Inventor: Chuang WEI, Beijing (CN)

(21) Appl. No.: 15/920,982

(22) Filed: Mar. 14, 2018

(30) Foreign Application Priority Data
Aug. 3, 2017 (CN) 201710655551.5

(51) Int. Cl. H04L 29/08; G06Q 50/26

(52) U.S. Cl. CPC H04L 67/32; H04L 67/12; G06Q 50/26

(57) ABSTRACT

The disclosure provides a public facility system, a user terminal, a server, and an internet of things system, where the public facility system includes a toilet device, a cleaning device, and an information acquisition device; where the information acquisition device is configured to acquire usage status information of the toilet device and/or the cleaning device, and to provide a user with the usage status information.

### CROSS-REFERENCE TO RELATED APPLICATION

This application claims priority to Chinese Patent Application No. 201710655551.5, filed on Aug. 3, 2017, which is hereby incorporated by reference in its entirety.

### TECHNICAL FIELD

The present disclosure relates to the field of electrics, and particularly to a public facility system, a user terminal, a server, and an internet of things system.

### DESCRIPTION OF THE RELATED ART

As the modern civilization is advancing, public facility systems, e.g., toilets, etc., have been indispensable in people's lives, particularly in both urban developments and domesticities. However when a person stays outside a public facility system, it is difficult for the person to obtain information about the inside of the public facility system, or the person has to obtain the information by having a word with someone inside the public facility system. Further, it is impossible for the person to know the usage conditions of all the public facility systems in some area, thus people frequently queue at some public facility system and wait for an access thereto, thus greatly wasting people's time, and degrading the operating efficiency of the public facility systems.

### SUMMARY

Embodiments of the disclosure provide a public facility system, a user terminal, a server, and an internet of things system.

In an aspect, an embodiment of the disclosure provides a public facility system including: a toilet device, a cleaning device, and an information acquisition device; wherein the information acquisition device is configured to acquire usage status information of the toilet device and/or the cleaning device, and to provide a user with the usage status information.

In another aspect, an embodiment of the disclosure provides a user terminal including at least one processor and a memory, wherein the memory is configured to store computer readable program codes; and the at least one processor is configured to execute the computer readable program codes to: locate the user terminal, and obtain usage status information of each public facility system above according to the embodiment of the disclosure in a set area from a server; and output the usage status information of the each public facility system in the set area to a user in a set priority order.

In still another aspect, an embodiment of the disclosure provides a server including at least one processor and a memory, wherein the memory is configured to store computer readable program codes; and the at least one processor is configured to execute the computer readable program codes to: receive usage status information of a public facility system; and transmit the usage status information of the public facility system to a user terminal in response to a request of the user terminal; wherein the public facility system includes a toilet device, a cleaning device, and an information acquisition device; wherein the information acquisition device is configured to acquire usage status information of the toilet device and/or the cleaning device, and to provide a user with the usage status information of the toilet device and/or the cleaning device.

In a further aspect, an embodiment of the disclosure provides an internet of things system including a public facility system, wherein the public facility system includes a toilet device, a cleaning device, and an information acquisition device; wherein the information acquisition device is configured to acquire usage status information of the toilet device and/or the cleaning device, and to provide a user with the usage status information of the toilet device and/or the cleaning device.

### BRIEF DESCRIPTION OF THE DRAWINGS

In order to make the technical solutions according to the embodiments of the disclosure more apparent, the drawings to which a description of the embodiments refers will be briefly introduced below, and apparently the drawings to be described below are merely illustrative of some of the embodiments of the disclosure, and those ordinarily skilled in the art can derive from these drawings other drawings without any inventive effort.

FIG. 1 is a schematic structural diagram of a public facility system according to an embodiment of the disclosure;

FIG. 2A is a first schematic diagram of an information acquisition device according to an embodiment of the disclosure in operation;

FIG. 2B is a second schematic diagram of an information acquisition device according to an embodiment of the disclosure in operation;

FIG. 2C is a third schematic diagram of an information acquisition device according to an embodiment of the disclosure in operation;

FIG. 2D is a fourth schematic diagram of an information acquisition device according to an embodiment of the disclosure in operation;

FIG. 2E is a fifth schematic diagram of an information acquisition device according to an embodiment of the disclosure in operation;

FIG. 2F is a sixth schematic diagram of an information acquisition device according to an embodiment of the disclosure in operation;

FIG. 2G is a seventh schematic diagram of an information acquisition device according to an embodiment of the disclosure in operation;

FIG. 3 is a schematic structural diagram of a user terminal according to an embodiment of the disclosure;

FIG. 4 is a schematic structural diagram of a server according to an embodiment of the disclosure;

FIG. 5 is a schematic structural diagram of an internet of things system according to an embodiment of the disclosure; and

FIG. 6 is a program flow chart of an internet of things system according to an embodiment of the disclosure.

### DETAILED DESCRIPTION OF THE EMBODIMENTS

In order to make the objects, technical solutions, and advantages of the disclosure more apparent, the disclosure will be described below in further details with reference to the drawings, and apparently the embodiments described below are only a part but not all of the embodiments of the disclosure. Based upon the embodiments here of the disclosure, all the other embodiments which can occur to those ordinarily skilled in the art without any inventive effort shall fall into the scope of the disclosure.

The shapes and sizes of respective components in the drawings are not intended to reflect any real proportion, but only intended to illustrate the content of the disclosure.

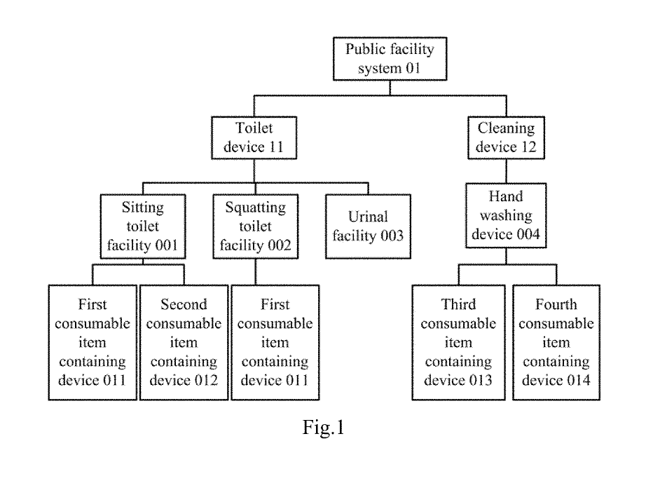

Embodiments of the disclosure provide a public facility system, as illustrated in FIG. 1, the public facility system 01 includes a toilet device 11, a cleaning device 12, and an information acquisition device (not illustrated in FIG. 1); where the information acquisition device is configured to acquire usage status information of the toilet device 11 and/or the cleaning device 12, and to provide a user with the usage status information.

In some embodiments, the toilet device 11 includes one or more of following kinds of toilet facilities: a sitting toilet facility 001, a squatting toilet facility 002, and a urinal facility 003. Where the number of each kind of toilet facility in the toilet device 11 can be one or more. For example, the toilet device 11 can include three sitting toilet facilities 001, or can include two sitting toilet facilities 001 and one squatting toilet facility 002, or can include one sitting toilet facility 001, two squatting toilet facilities 002, and one urinal facility 003, etc.

In some embodiments, each toilet facility in the toilet device 11 corresponds to one information acquisition device configured to acquire usage status information indicating that whether the toilet facility is occupied by someone.

In some embodiments, the toilet device 11 further includes at least one kind of consumable item containing device.

In some embodiments, the at least one kind of consumable item containing device in the toilet device 11 includes a first consumable item containing device 011, or includes a first consumable item containing device 011 and a second consumable item containing device 012.

For example, each sitting toilet facility 001 in the toilet device 11 can be arranged with one corresponding first consumable item containing device 011 and one corresponding second consumable item containing device 012, or can be arranged with only one corresponding first consumable item containing device 011; and each squatting toilet facility 002 in the toilet device 11 can be arranged with one corresponding first consumable item containing device 011.

In some embodiments, each consumable item containing device in the toilet device 11 is arranged with one corresponding information acquisition device configured to acquire information about a remaining amount of a consumable item of the consumable item containing device, and to provide the user with the information about the remaining amount of the consumable item.

In some embodiments, the cleaning device 12 includes a hand washing device 004 and at least one kind of consumable item containing device, where the number of hand washing device(s) 004 in the cleaning device 12 can be one or more. Furthermore the at least one kind of consumable item containing device in the cleaning device 12 includes a third consumable item containing device 013 and a fourth consumable item containing device 014.

For example, each hand washing device 004 in the cleaning device 12 can be arranged with one corresponding third consumable item containing device 013 and one fourth consumable item containing device 014.

In some embodiments, each consumable item containing device in the cleaning device 12 is arranged with one corresponding information acquisition device configured to acquire information about a remaining amount of a consumable item of the consumable item containing device, and to provide the user with the information about the remaining amount of the consumable item.

In some embodiments, in the public facility system above according to the embodiments of the disclosure, the first consumable item containing device 011 can be a toilet paper containing device; the second consumable item containing device 012 can be a seat paper containing device; the third consumable item containing device 013 can be a hand sanitizer containing device; and the fourth consumable item containing device 014 can be a paper towel containing device.

In some embodiments, in the public facility system above according to the embodiments of the disclosure, there is a corresponding information acquisition device installed for any one of the devices above, and each information acquisition device includes a sensor and a signal transmitting device, where the sensor is configured to acquire a usage status information of a corresponding device, or information about a remaining amount of a consumable item of the corresponding device; and the signal transmitting device is configured to provide the user with the information acquired by the sensor.

In some embodiments, the sensor can be an infrared sensor and/or a gravity sensor; and the signal transmitting device can be a Bluetooth device, a Wi-Fi (Wireless Fidelity) device, or a non-contact radio frequency recognition device; that is, the signal transmitting device can provide the user with the acquired information wirelessly.

The operating process of the information acquisition device will be described below by way of an example.

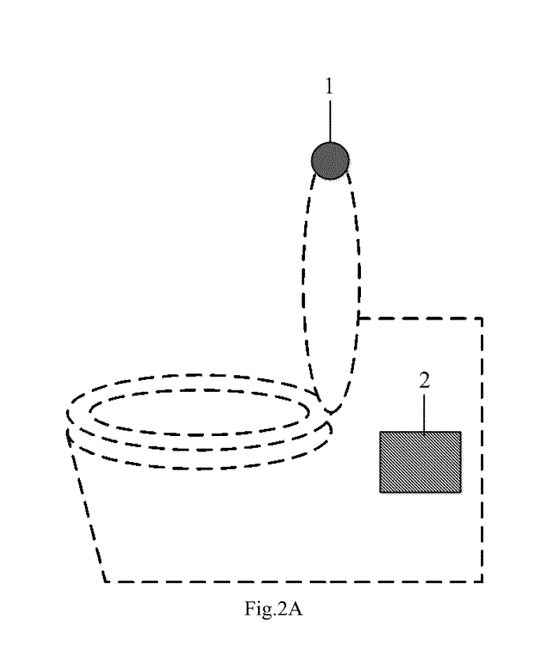

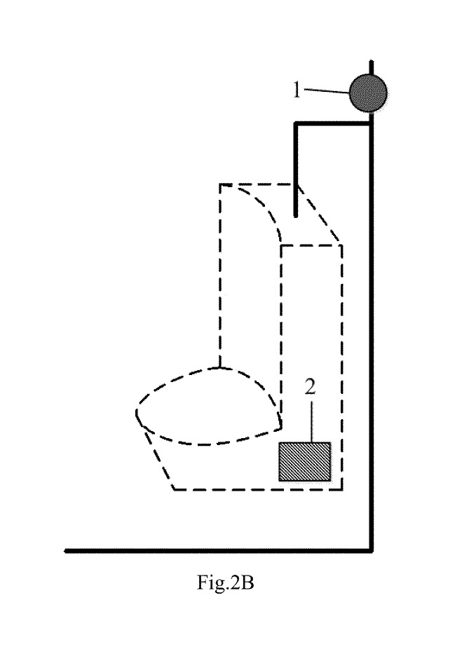

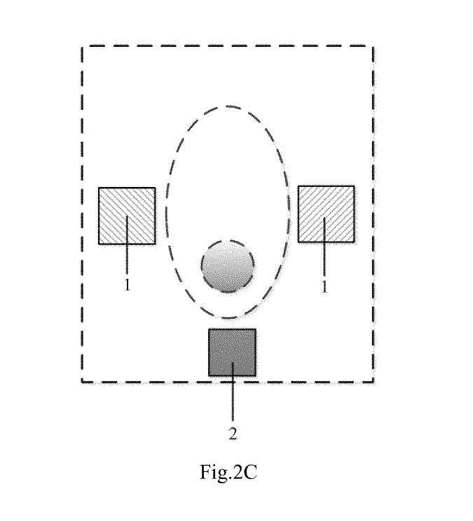

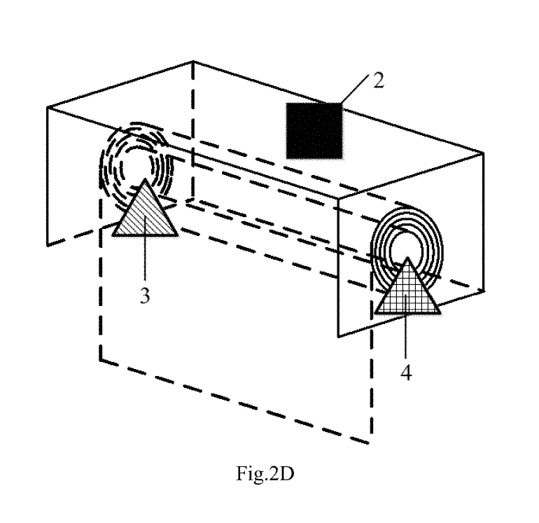

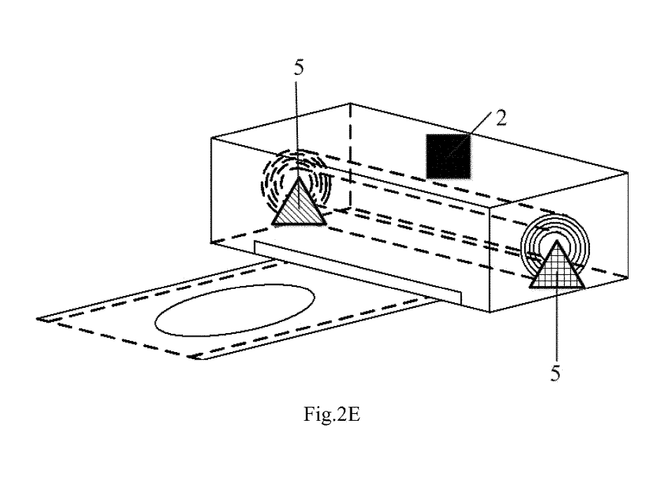

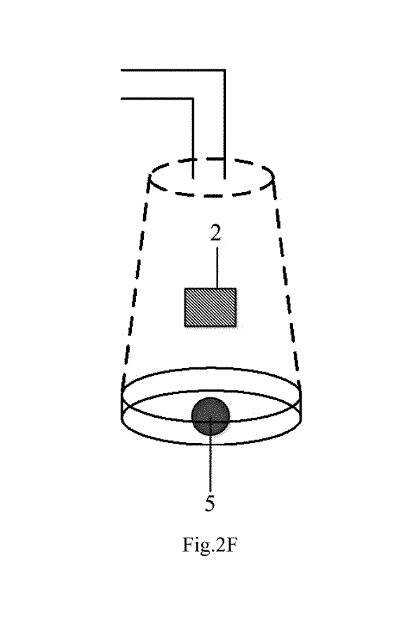

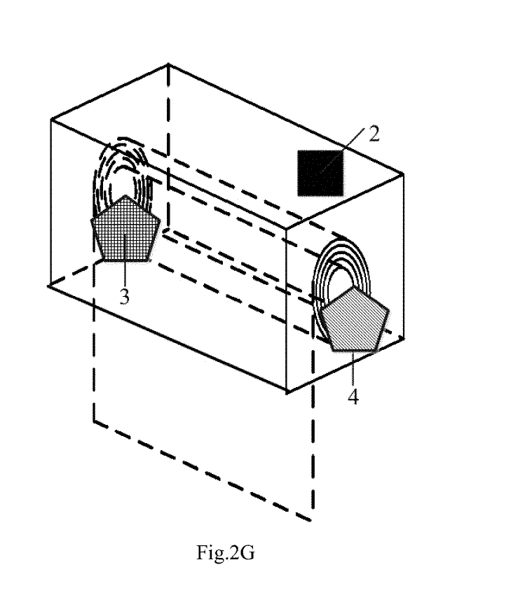

As illustrated in FIG. 2A, taking a corresponding information acquisition device arranged for a sitting toilet facility as an example, the information acquisition device can include an infrared sensor 1 and a signal transmitting device 2, both of which are installed on the sitting toilet facility. Where the infrared sensor 1 can detect in real time whether someone is occupying the sitting toilet facility, by sensing an infrared signal transmitted from a human body, and feed detected usage status information back to the public facility system or the user through the signal transmitting device 2.

As illustrated in FIG. 2B, taking a corresponding information acquisition device arranged for a urinal facility as an example, the information acquisition device can include an infrared sensor 1 installed on a upper side of the urinal facility, and a signal transmitting device 2 installed on a left or right side of the urinal facility. Where the infrared sensor 1 can detect in real time whether someone is occupying the urinal facility, by sensing an infrared signal transmitted from a human body, and feed detected usage status information back to the public facility system or the user through the signal transmitting device 2.

As illustrated in FIG. 2C, taking a corresponding information acquisition device arranged for a squatting toilet facility as an example, the information acquisition device can include two infrared sensors 1 installed on two sides of the squatting toilet facility, and a signal transmitting device 2. Where the two infrared sensors 1 can detect in real time whether someone is occupying the squatting toilet facility, by sensing an infrared signal transmitted from a human body, and feed detected usage status information back to the public facility system or the user through the signal transmitting device 2.

As illustrated in FIG. 2D, taking a corresponding information acquisition device arranged for a toilet paper containing device as an example, the information acquisition device can include an infrared transmitting device 3 and an infrared receiving device 4 arranged respectively on left and right sides of the toilet paper containing device, and a signal transmitting device 2. Where the infrared transmitting device 3 transmits an infrared signal to the infrared receiving device 4 at some frequency, and when there is toilet paper remaining, the infrared signal transmitted by the infrared transmitting device 3 is blocked by the toilet paper instead of arriving at the infrared receiving device 4, but when the infrared receiving device 4 can receive the infrared signal transmitted by the infrared transmitting device 3, it indicates that the toilet paper has been used up. The infrared receiving device 4 detects in real time a usage status of the toilet paper, and feeds detected information back to the public facility system or the user through the signal transmitting device 2.

As illustrated in FIG. 2E, taking a corresponding information acquisition device arranged for a seat paper containing device as an example, the information acquisition device can include two gravity sensors 5 arranged on a shaft of the seat paper containing device, and a signal transmitting device 2. Where the two gravity sensors 5 detect in real time an overall weight of the shaft of the seat paper containing device, and feed a signal back to the public facility system or the user through the signal transmitting device 2. A remaining amount of seat paper is calculated in an equation of

$${G}_{z} \% = \frac{{G}_{M} - {G}_{M 0}}{{G}_{MF} - {G}_{M 0}} \times 100 \% ,$$

where G_{z}% is a percentage of the remaining amount of the seat paper, G_{M} is a detected real-time weight of the shaft, G_{M0} is a weight of the shaft which is unloaded, and G_{MF} is an overall weight of the seat paper containing device fully loaded with the seat paper.

As illustrated in FIG. 2F, taking a corresponding information acquisition device arranged for a hand sanitizer containing device as an example, the information acquisition device can include a gravity sensor 5 arranged on the bottom of the hand sanitizer containing device, and a signal transmitting device 2 arranged on an outer casing of the hand sanitizer containing device. The gravity sensor 5 detects in real time an overall weight of the hand sanitizer containing device, and feeds detected information back to the public facility system or the user through the signal transmitting device 2. A remaining amount of hand sanitizer is calculated in an equation of

$$Gs \% = \frac{{G}_{K} - {G}_{0}}{{G}_{F} - {G}_{0}} \times 100 \% ,$$

where Gs % is a percentage of the remaining amount of the hand sanitizer, G_{K} is a detected real-time weight of the hand sanitizer containing device, G₀ is a weight of the hand sanitizer containing device which is emptied, and G_{F} is an overall weight of the hand sanitizer containing device fully loaded with the hand sanitizer.

As illustrated in FIG. 2G, taking a corresponding information acquisition device arranged for a paper towel containing device as an example, the information acquisition device can include an infrared transmitting device 3 and an infrared receiving device 4 arranged respectively on left and right sides of the towel containing device, and a signal transmitting device 2. Where the infrared transmitting device 3 transmits an infrared signal to the infrared receiving device 4 at some frequency, and when there is paper towel remaining, the infrared signal transmitted by the infrared transmitting device 3 is blocked by the paper towel instead of arriving at the infrared receiving device 4, but when the infrared receiving device 4 can receive the infrared signal transmitted by the infrared transmitting device 3, it indicates that the paper towel has been used up. The infrared receiving device 4 detects in real time a usage status of the paper towel, and feeds detected information back to the public facility system or the user through the signal transmitting device 2.

In some embodiments, in the public facility system above according to the embodiments of the disclosure, the sensor can be installed at a number of positions, although the embodiments of the disclosure will not be limited thereto.

In some embodiments, in the public facility system above according to the embodiments of the disclosure, the signal transmitting device and the sensor can be connected in a number of modes, and for example, they can be electrically connected via an integrated circuit board, or can be connected wirelessly.

In some embodiments, in the public facility system above according to the embodiments of the disclosure, the public facility system further includes a display device.

The display device can be arranged outside of the public facility system to receive the usage status information of the toilet device and/or the cleaning device acquired by the information acquisition device directly, or to receive the usage status information of the toilet device and/or the cleaning device, acquired by the information acquisition device, forwarded by a server, and display it to the user in real time. Stated otherwise, in the public facility system above according to the embodiments of the disclosure, the display device and the information acquisition device can communicate in a number of modes, some of which will be described below by way of an example.

In an implementation, a radio signal receiving device is installed on the display device, and the display device receives directly the usage status information of the toilet device and/or the cleaning device acquired by the information acquisition device in the public facility system including the display device through the radio signal receiving device, and displays it to the user.

In another implementation, a network communication device is installed on the display device, and the display device is networked through the network communication device with the server, receives usage status information of the public facility system including the display device (such as the usage status information of the toilet device and/or the cleaning device of the public facility system including the display device), or usage status information of another public facility system nearby, through the server, and displays it to the user.

In some embodiments, in the public facility system above according to the embodiments of the disclosure, the information displayed by the display device to the user can include one or more of following information: the availability of each toilet facility, the remaining amount of the toilet paper, the remaining amount of the seat paper, the remaining amount of the hand towel, and the remaining amount of the hand sanitizer, for example.

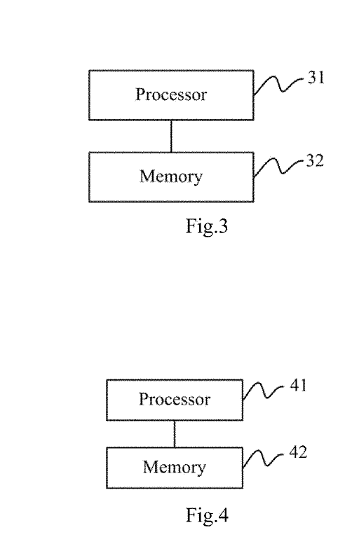

Based upon the same concept of the disclosure, embodiments of the disclosure further provide a user terminal. As illustrated in FIG. 3, the user terminal according to the embodiments of the disclosure includes at least one processor 31, and a memory 32, where the memory 32 is configured to store computer readable program codes; and the at least one processor 31 is configured to execute the computer readable program codes to: locate the user terminal, and obtain usage status information of each public facility system above according to the embodiments of the disclosure in a set area from a server; and output the usage status information of the each public facility system in the set area to a user in a set priority order.

In some embodiments, in the user terminal above according to the embodiments of the disclosure, the set area can be within 500 meters or within 100 meters, for example, although the embodiments of the disclosure will not be limited thereto because the set area can be set as needed in practical.

In some embodiments, in the user terminal above according to the embodiments of the disclosure, when the user terminal makes a location request, the at least one processor 31 locates the user terminal, and then searches for usage status information of all the public facility system(s) in the set area according to a position of the user terminal, and sorts the usage status information in the set priority order, where the set priority order includes following two sorting rules.

A first sorting rule: the usage status information is sorted in an order of a distance between each public facility system and the user terminal; for example, usage status information of a public facility system nearest to the user terminal is sorted highest.

A second sorting rule: the usage status information is sorted in an order of an idle degree of each public facility system; for example, usage status information of a least occupied public facility system is sorted highest.

In some embodiments, in the user terminal above according to the embodiments of the disclosure, the priority order is generated by using at least one of the sorting rules above, although the embodiments of the disclosure will not be limited thereto.

The sorting rule(s) used during the generation of the priority order can be described below by way of an example.

In an implementation, the priority order is only determined according to the distance of each public facility system. After the at least one processor 31 obtains positional information of the user terminal, it obtains positional information of all the public facility system(s) in the set area, and calculates the distance between each public facility system in the set area and the user terminal respectively, sorts the public facility system(s) in an order of the distance(s) thereof, and thereby determines the priority order.

In another implementation, the priority order is only determined according to the idle degree of each public facility system. After the at least one processor 31 obtains the positional information of the user terminal, it obtains usage status information of all the public facility system(s) in the set area; and sorts the public facility system(s) in a descending order of the idle degree(s) thereof, and thereby determines the priority order.

In still another implementation, the priority order is determined according to both the distance and the idle degree of each public facility system. After the at least one processor 31 obtains the positional information of the user terminal, it obtains positional information and usage status information of all the public facility system(s) in the set area, and calculates the distance between each public facility system in the set area and the user terminal respectively, sorts the public facility system(s) in an order of both the distance and the idle degree thereof, which are weighted using respective set weights, and thereby determines the priority order.

Based upon the same inventive concept, embodiments of the disclosure further provide a server. As illustrated in FIG. 4, the server according to the embodiments of the disclosure includes at least one processor 41, and a memory 42, where the memory 42 is configured to store computer readable program codes; and the at least one processor 41 is configured to execute the computer readable program codes to: receive usage status information of the public facility system(s); and transmit the usage status information of the public facility system(s) to a user terminal in response to a request of the user terminal.

In some embodiments, the server can communicate with the information acquisition device(s) in each public facility system over a network, receive in real time usage status information of the toilet device and/or the cleaning device acquired by the information acquisition device(s) in the each public facility system, and transmit the received usage status information to the user terminal(s), and/or the display device of the each public facility system.

In some embodiments, the server further includes a central management console configured to manage the public facility system(s) and/or the user terminal(s); for example, to manage the usage status information of the public facility system(s), and positional information of the public facility system(s) and the user terminal(s).

In some embodiments, in the server above according to the embodiments of the disclosure, the central management console can be a computer, which can receive data transmitted from the information acquisition device(s) in all the public facility system(s) served by the server, and the request(s) transmitted by the user terminal(s), and can monitor and maintain the usage status information of all the public facility system(s), and the positional information of the user terminal(s) transmitting the request(s).

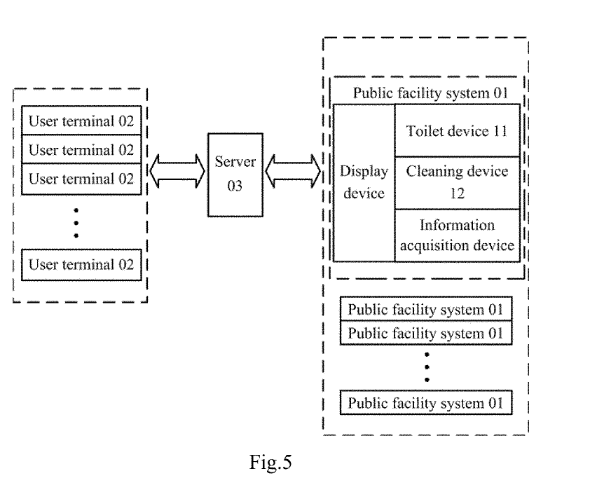

Based upon the same inventive concept, embodiments of the disclosure further provide an internet of things system including one or more of a public facility system, a user terminal, and a server according to the embodiments of the disclosure. FIG. 5 illustrates the internet of things system including a public facility system 01, a user terminal 02, and a server 03 above according to the embodiments of the disclosure, where the number of the public facility system(s) 01 in the internet of things system may be one or more, the number of the user terminal(s) 02 may be one or more, and the number of the server(s) 03 may also be one or more, although the embodiments of the disclosure will not be limited thereto. Furthermore the internet of things system may be embodied in a number of forms, and the public facility system(s), the user terminal(s), and the server(s) can operate in cooperation in a customized program flow.

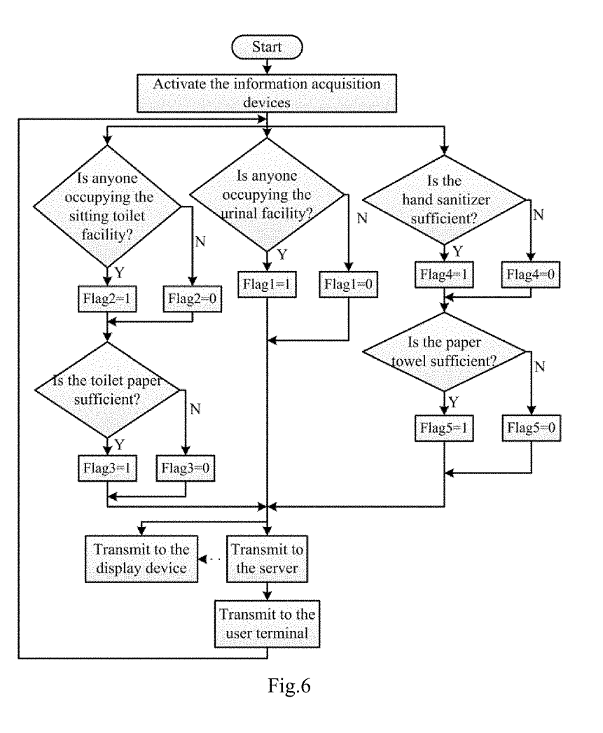

FIG. 6 illustrates a program flow chart of an internet of things system including a public facility system including one urinal facility, one sitting toilet facility, and one hand washing device, a server, and a user terminal, as an operating flow of the internet of things system, where information acquisition devices in the public facility system detect in real time usage status information of respective devices after they are activated. Flag1 is an identifier of a sensor installed on the urinal facility, where Flag1=1 indicates that the urinal facility is occupied by someone, and Flag1=0 indicates that the urinal facility is unoccupied; Flag2 is an identifier of a sensor installed on the sitting toilet facility, where Flag2=1 indicates that the sitting toilet facility is occupied by someone, and Flag2=0 indicates that the sitting toilet facility is unoccupied; Flag3 is an identifier of a sensor installed on a toilet paper containing device, where Flag3=1 indicates that toilet paper remains available, and Flag3=0 indicates that the toilet paper is used up, and needs to be supplemented; Flag4 is an identifier of a sensor installed on a hand sanitizer containing device, where Flag4=1 indicates that hand sanitizer remains available, and Flag4=0 indicates that the hand sanitizer is used up, and needs to be supplemented; and Flag5 is an identifier of a sensor installed on a paper towel containing device, where Flag5=1 indicates that a paper towel remains available, and Flag5=0 indicates that the paper towel is used up, and needs to be supplemented. The information acquisition devices further transmit identifiers of usage status information of respective devices to the server, and/or a display device of the public facility system, so as to provide a user with the usage status information.

The embodiments of the disclosure provide a public facility system, a user terminal, a server, and an internet of things system, and the internet of things system can include a toilet device, a cleaning device, an information acquisition device, the server, and the user terminal. The information acquisition device acquires usage status information of the toilet device and/or the cleaning device, and transmits the usage status information to the server, and the server further provides a user with the usage status information through the user terminal. Also the user can search initiatively via the user terminal for the public facility system(s) nearby, and obtain usage condition(s) thereof, so that the user can know the usage condition(s) of the public facility system(s) conveniently at any place, thus improving the convenience of the user to access the public facility system(s), shortening a period of time for the user to queue and wait, and improving the operating efficiency of the public facility system(s).

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A public facility system, comprising: a toilet device, a cleaning device, and an information acquisition device; wherein the information acquisition device is configured to acquire usage status information of the toilet device and/or the cleaning device, and to provide a user with the usage status information.

2. The public facility system according to claim 1, wherein the information acquisition device is configured to transmit the usage status information to a server, so as to provide the user with the usage status information via the server.

3. The public facility system according to claim 1, wherein the toilet device comprises one or more of following kinds of toilet facilities: a urinal facility, a sitting toilet facility, and a squatting toilet facility;
wherein each toilet facility in the toilet device is arranged with one corresponding information acquisition device configured to acquire usage status information indicating whether the toilet facility is occupied.

4. The public facility system according to claim 1, wherein the toilet device further comprises at least one kind of consumable item containing device; and each consumable item containing device in the toilet device is arranged with one corresponding information acquisition device configured to acquire information about a remaining amount of a consumable item of the consumable item containing device, and to provide the user with the information about the remaining amount of the consumable item.

5. The public facility system according to claim 4, wherein the at least one kind of consumable item containing device comprises a first consumable item containing device and a second consumable item containing device.

6. The public facility system according to claim 1, wherein the cleaning device comprises a hand washing device and at least one kind of consumable item containing device; and each consumable item containing device in the cleaning device is arranged with one corresponding information acquisition device configured to acquire information about a remaining amount of a consumable item of the consumable item containing device, and to provide the user with the information about the remaining amount of the consumable item.

7. The public facility system according to claim 6, wherein the at least one kind of consumable item containing device comprises a third consumable item containing device and a fourth consumable item containing device.

8. The public facility system according to claim 1, wherein the information acquisition device comprises a sensor and a signal transmitting device;
the sensor is configured to detect the usage status information of the toilet device and/or the cleaning device; and
the signal transmitting device is configured to provide the user with the usage status information.

9. The public facility system according to claim 8, wherein the sensor comprises an infrared sensor and/or a gravity sensor.

10. The public facility system according to claim 8, wherein the signal transmitting device comprises a Bluetooth device, a Wireless Fidelity device, or a non-contact radio frequency recognition device.

11. The public facility system according to claim 1, wherein the public facility system further comprises a display device configured to receive and display the usage status information.

12. A user terminal, comprising at least one processor, and a memory, wherein:
the memory is configured to store computer readable program codes; and
the at least one processor is configured to execute the computer readable program codes to:
locate the user terminal, and obtain usage status information of each public facility system according to claim 1 in a set area from a server; and
output the usage status information of the each public facility system in the set area to a user in a set priority order.

13. The user terminal according to claim 12, wherein the set priority order is a priority order determined using at least one or more of following sorting rules:
the usage status information of the each public facility system is sorted in an order of a distance between the each public facility system and the user terminal; and
the usage status information of the each public facility system is sorted in an order of an idle degree of the each public facility system.

14. A server, comprising at least one processor, and a memory, wherein:
the memory is configured to store computer readable program codes; and
the at least one processor is configured to execute the computer readable program codes to:
receive usage status information of a public facility system; and
transmit the usage status information of the public facility system to a user terminal in response to a request of the user terminal;
wherein the public facility system comprises: a toilet device, a cleaning device, and an information acquisition device; wherein the information acquisition device is configured to acquire usage status information of the toilet device and/or the cleaning device, and to provide a user with the usage status information of the toilet device and/or the cleaning device.

15. The server according to claim 14, wherein the server further comprises a central management console configured to manage the public facility system and/or the user terminal.

16. An internet of things system, comprising:
a public facility system; wherein the public facility system comprises a toilet device, a cleaning device, and an information acquisition device; wherein the information acquisition device is configured to acquire usage status information of the toilet device and/or the cleaning device, and to provide a user with the usage status information of the toilet device and/or the cleaning device.

17. The internet of things system according to claim 16, wherein the internet of things system further comprises a user terminal; wherein the user terminal is configured to locate the user terminal, and obtain usage status information of each public facility system in a set area from a server, and to output the usage status information of the each public facility system in the set area to the user in a set priority order.

18. The internet of things system according to claim 16, wherein the internet of things system further comprises a server; wherein the server is configured to: receive usage status information of the public facility system, and to transmit the usage status information of the public facility system to a user terminal in response to a request of the user terminal.
